(19) United States
(12) Patent Application Publication
(10) Pub. No.: US 2020/0175767 A1
(43) Pub. Date: Jun. 4, 2020

(54) SYSTEMS AND METHODS FOR DYNAMICALLY IDENTIFYING HAZARDS, ROUTING RESOURCES, AND MONITORING AND TRAINING OF PERSONS

(71) Applicant: GoWare, Inc., Irvine, CA (US)

(72) Inventors: Alon Oliver Stivi, Irvine, CA (US); John Nall, Irvine, CA (US); Satwant Singh Atwal, Irvine, CA (US); Stephen Damian Marlow, Irvine, CA (US)

(21) Appl. No.: 16/330,699

(22) PCT Filed: Sep. 6, 2017
(86) PCT No.: PCT/US17/50295

§ 371 Date: Mar. 5, 2019

Related U.S. Application Data
(60) Provisional application No. 62/384,001, filed on Sep. 6, 2016.
(60) Provisional application No. 62/384,006, filed on Sep. 6, 2016.
(60) Provisional application No. 62/384,012, filed on Sep. 6, 2016.
(60) Provisional application No. 62/384,017, filed on Sep. 6, 2016.
(60) Provisional application No. 62/384,022, filed on Sep. 6, 2016.

(51) Int. Cl. G06T 19/00; H04W 4/021; G06T 15/20; G01C 21/34

(52) U.S. Cl. CPC G06T 19/006; G01C 21/3461; G06T 15/20; H04W 4/021

(57) ABSTRACT

Systems and methods are described for dynamically managing a hazard. Systems and methods are described for monitoring a location of a hazard and predicting its movement based on received information about the hazard and known information about the site where the hazard is located. Users can be directed or redirected based on the hazard or incident and the need to contain the hazard while providing coverage on previously assigned patrol routes. The information can be used to learn what occurred at a hazard and update patrol routes and instructions for users when responding to an incident, and to predict future hazard movement.

This application claims the benefit of priority to the following applications: U.S. provisional application No. 62/384,001 filed on Sep. 6, 2016; U.S. provisional application No. 62/384,006 filed on Sep. 6, 2016; U.S. provisional application No. 62/384,012 filed on Sep. 6, 2016; U.S. provisional application No. 62/384,017 filed on Sep. 6, 2016; and U.S. provisional application No. 62/384,022 filed on Sep. 6, 2016. These and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention is software systems for managing security, emergency response, and personal safety.

### BACKGROUND

The following description includes information that may be useful in understanding the present invention. It is not an admission that any of the information provided herein is prior art or relevant to the presently claimed invention, or that any publication specifically or implicitly referenced is prior art.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

The security industry provides guard services based on the models first developed thousands of years ago (guards walking specific routes, on the lookout for intrusions). These models have been slow to adapt to advances in technologies that would enhance effectiveness or efficiency. Reliability of services varies greatly based on guard selection, training and oversight. Management is time consuming and marginally successful, with limited ability to react when faced with complex incidents. Guard services have become both expensive and predictable, with limited capabilities.

Personal security requirements have also changed dramatically. Annually, there are over 800 million passengers flying from US airports, and about 4 billion worldwide. Many business and leisure travelers may visit destinations in underdeveloped countries where the public safety and emergency response infrastructure is rudimentary or non-existent. As a result many travelers, particularly women and children, are exposed to various risks including mugging, rape, kidnapping, carjacking, terrorism and civil unrest.

Having real-time, visually-oriented user-based correlated information about a moving risk or hazard, associated with specific location features and trajectory, can significantly reduce the risk of exposure and allow users to take proactive measures to avoid, or intercept, the risk as necessary.

Considering population growth, advances in and availability of technology, the increasing complexity and impact of incidents of all types, the increased sophistication of criminal and terrorist threats, the need to adapt new solutions and adopt technologies to enable real-time visual guidance and awareness of dynamically evolving incidents is clear.

Thus, there is a need for an advanced software system that addresses the current and future needs in the security guard industry and personal safety.

### SUMMARY OF THE INVENTION

In some contemplated embodiments, the system/platform can include a hazard tagging module, which is configured to deliver high fidelity recognition and predictability of dynamic circumstances and accurately communicate the evolution or devolution of both stationary and mobile hazards. Through cross-examination and merging of information from multiple users, and other sensor and database/API input, the hazard tagging module is programmed to pinpoint the location and track the movement of hazards. The hazard tagging module is programmed to then provide users with the magnitude, shape, trajectory, distance, radius-of-impact and time-to-impact of hazards in relevance to the exact user positions and terrain/location features. The hazard tagging module's dynamic geo-fencing process can differentiate both two-dimensional (single-story) and three-dimensional (multi-story) facilities.

The system can further include a dynamic routing and resourcing module that is configured to (1) merge navigation and tracking technologies with workforce scheduling and financial analysis according to an evolution of an incident, to (2) randomize and coordinate the routing of users, and (3) to deploy personnel and allocate resources in relevance to the user's evolving circumstances and needs. The routing and resourcing module preferably delivers “when & where and what to” instructions and visual directional guidance to the user while providing management with command-in-progress and event horizon planning capabilities.

By leveraging tracking, hazards tagging, and geo-fencing capabilities combined with the system's trajectory and spatial orientation algorithms, the dynamic routing & resourcing module is able to achieve an unprecedented level of responsiveness and predictability/unpredictability for an unlimited number of users, simultaneously, to improve user safety, accountability and fiduciary responsibility. The dynamic routing & resourcing module is programmed to continuously track each user's location, and assess movement in relation to the other users and compared this data to the location and movement of hazards. The dynamic routing & resourcing module is programmed to guide the users toward, or away from, hazards and each other via the safest route of approach or evacuation.

The systems and methods described herein further allow for the combination of augmented reality, automatic and dynamically scaling hazard-tagging, geo fencing, site fingerprint, and location tracking technologies with vision analytics to demonstrate and communicate the location, movement and trajectory of hazards in relevance to the user's circumstances. The systems and methods can deliver “how, what and where to” instructions and real-time visual directional guidance to improve collaboration and coordination between users while improving safety of the user's during the tracking and apprehension processes.

By leveraging navigational tracking and three-dimensional, site-specific visualization capabilities, combined with the trajectory algorithm and user's input, the system displays a virtual representation of moving hazards through physical mediums. Each user's Point Of View is combined with other users to improve the hazard description and pinpoint the location and movement of hazards within a monitored area. Users are able to “see” the hazards through physical obstructions to understand its' exact location, direction and speed of movement, and (if appropriate) possible intercept point. Comparative analysis of images captured by users as well as onsite sensors, security systems and drones are integrated into a collective POV to improve timeliness and reliability of visualization.

In addition, it is contemplated that using the data collected during an incident from the various elements within the incident command and compliance module, the incident command and compliance module is programmed to provide a step-by-step recreation of events and timelines. This forensic analysis and reporting could be replayed in a Virtual Reality environment or reenacted at the site of the incident using Augmented Reality display at the specific location with the Augmented Reality playback device.

It is further contemplated that the systems and methods can include a quality control and machine learning module comprising a digital platform/system underpinning scheduled services delivery (such as guard patrols) will support real-time assessment of service delivery effectiveness and cost. Detailed performance metrics and on-going tracking of performance will enable machine learning and ensure ongoing productivity improvements.

The quality control and machine learning module merges navigation tracking and analytics technologies with Rule-Based procedures and performance algorithms. The quality control and machine learning module delivers “how to do better” instructions and operational guidance to the user and management to improve the quality of service.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a depiction of a hazard as could be presented to a user showing multiple zones of danger.

FIG. 2 illustrates an overlay of a moving hazard, with geo-fenced area representing line-of-fire, accounting for the physical features of the structures, on a digital map.

FIG. 3 illustrates a diagram of one embodiment of a trajectory algorithm.

FIGS. 4A-4B illustrates left and right halves of one embodiment of a process flow for creating an alert, including defining a hazard geo-location.

FIGS. 5A-5B illustrates one embodiment of a mobile application screen flow and content relationships for making an alert using the interface, including defining a hazard geo-location.

FIG. 6 illustrates an example of a k-nearest neighbor classification.

FIG. 7 illustrates an outline of a primal-dual algorithm.

FIG. 8 illustrates another embodiment of a series of mobile application screens.

FIG. 9 illustrates one embodiment of a system architecture.

FIG. 10 defines one embodiment of a system network, illustrating compatibility with exemplary static, mobile and wearable interfaces.

FIG. 11 illustrates another embodiment of a system architecture, from the perspective of a user's client device.

FIG. 12 is a photo of an example of a randomized patrol route as presented on the interface.

FIG. 13 is a photo of an example of a patroller's view interface, showing an augmented reality dispatch instruction relating to a specific checkpoint.

FIG. 14 is a photo of a patroller/security guard's mobile device, illustrating an exemplary movement of a hazard. The drawn input directional arrow can be geo-spatially integrated by the system.

FIG. 15 is a photo of a patroller/security guard's mobile device, illustrating an exemplary interface for tagging of a hazard, and establishing an impact boundary/geo-fence.

FIG. 16 is a photo of a patroller's mobile device, illustrating an exemplary interface showing precise, real-time geo-location of all patrollers at the site.

FIG. 17 illustrates an exemplary outline of the cycle cancelling algorithm.

FIG. 18 illustrates an example of a successive shortest path algorithm.

FIG. 19 illustrates a B-Tree insertion example.

FIG. 20 illustrates an example of a decision tree.

FIG. 21 illustrates one embodiment of an organizational chart for an incident command system.

### DETAILED DESCRIPTION

Throughout the following discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions. One should appreciate that the systems and methods described herein allow for the culmination of information and data from multiple sources, including user input, cameras, sensors, and other data sources to identify and track hazards over time, as well as create and monitor patrol routes for users. This information can be then reviewed and analyzed to improve future responses and adjust future patrol routes to maximum coverage and response while minimizing costs.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

### Automatic and Dynamically Scaling Hazard-Tagging and Geo-Fencing

The hazard tagging module of some embodiments is programmed to merge navigation and geo-fencing technologies with hazard tagging and trajectory algorithms to identify and communicate the location and movement of hazards in relevance to the mobile users' circumstances. It delivers “who, what and where to” instructions and provides real-time visual directional guidance to improve responsiveness and safety for users on the go.

As defined herein, a “hazard” can be a natural disaster (e.g., a fire, earthquake, tsunami, flood, etc.), a man-made intentional or accidental hazard (e.g., a shooting, robbery, riot, explosion, chemical spill, traffic accident, structural collapse, etc.), a missing user or patroller, and/or any other situation that requires an emergency response to mitigate or contain the hazard.

While the below discussion focuses on security personnel or first responders, it is contemplated that the terms “user” and “patrollers” could include military officers, private security, parking enforcement, construction workers, law enforcement, and any other industry that requires coordination of response to hazards or random inspections and quality control supervision.

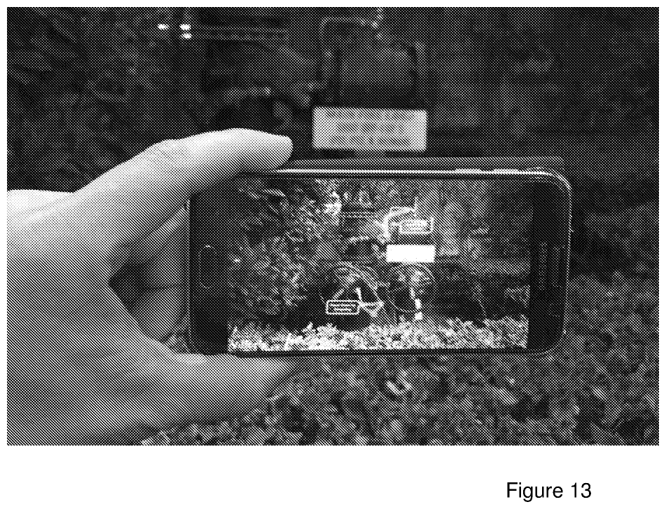

In one contemplated embodiment, the system 100 can include a server 110 having a plurality of modules, each of which has a predefined role and function. Contemplated modules include, for example, an admin module for customizing the software, adding users, changing user rights, and so forth. A geo-fence and hazard module (hazard tagging module) can be used to receive input from sources and identify and notify users about a hazard including its current or projected movement. A navigation and tracking module (dynamic routing and resourcing module) can be used alone or in conjunction with a randomizer module, for example, to generate randomized patrol routes and track progress of users, such as via completion of checkpoints. A machine learning module (quality control and machine learning module) can be used to analyze data from current and past patrols and incidents to improve accuracy of projections of hazard movements and modify future patrol routes, for example. An augmented reality (A/R or AR) module (augmented reality intercept module) can be used to generate an A/R overlay that can allow users to visualize checkpoints or hazards via a mobile device such as a smart phone. See FIG. 13. Preferably, the A/R module allows for the generation of a user-specific point of view of a hazard, where the user can view a rendering of the hazard and its specific real world location even where obstacles such as a building block the view. Any or all of the modules can receive or store information in one or more databases 120 that include site or location fingerprints, geo fencing coordinates, maps, processes and procedures such as NIMS/ICS regulations, and so forth.

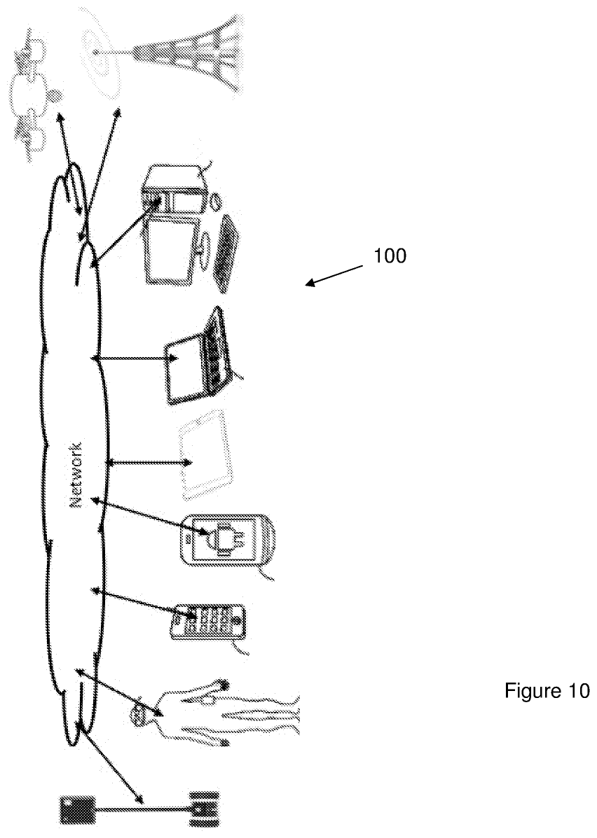

FIG. 10 illustrates how users, devices and sensors can all be connected with the system 100 via one or more networks to allow information to be moved bi-directional between users and the system, sensors, and between users themselves.

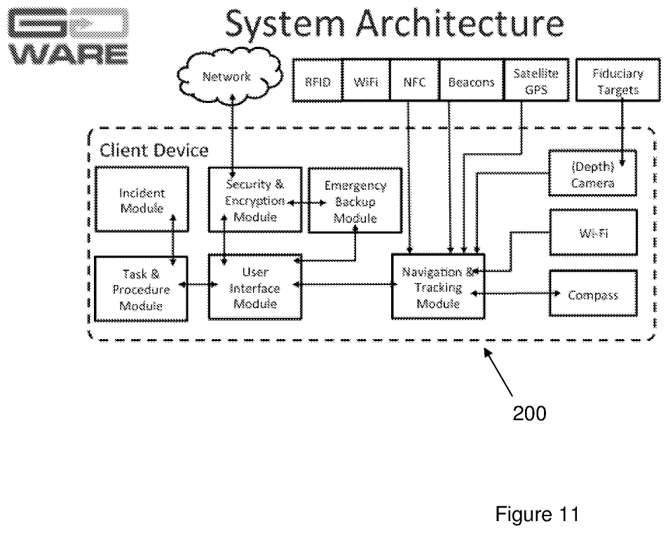

FIG. 11 illustrates one embodiment of an architecture of a system 200 as installed on a user device. Although various modules are shown in the Figure, it is contemplated that some or all of the modules could be located remotely from the device, such as on a remote server. In addition, other modules could be installed on the device. It is contemplated that the system allows the modules to received information from various sensors on the device, which may include a camera, GPS, compass, accelerometer, vital signs, and so forth.

### Example 1: Stationary or Slow-Moving Hazard—e.g. Fire or Flood

The hazard tagging module is programmed to provide an interface to users, preferably on a smart phone, watch, or other portable computing device, such that users can submit alerts either actively (such as via input into the interface) or passively (such as via data collected by the user or the user's device(s)—e.g., sensor, location, or camera data, etc.). The submitted alert may provide information that identifies an abnormal scenario, a suspicious individual/vehicle or object, for example. The alert may include an image along with a “pin” noting the originating location.

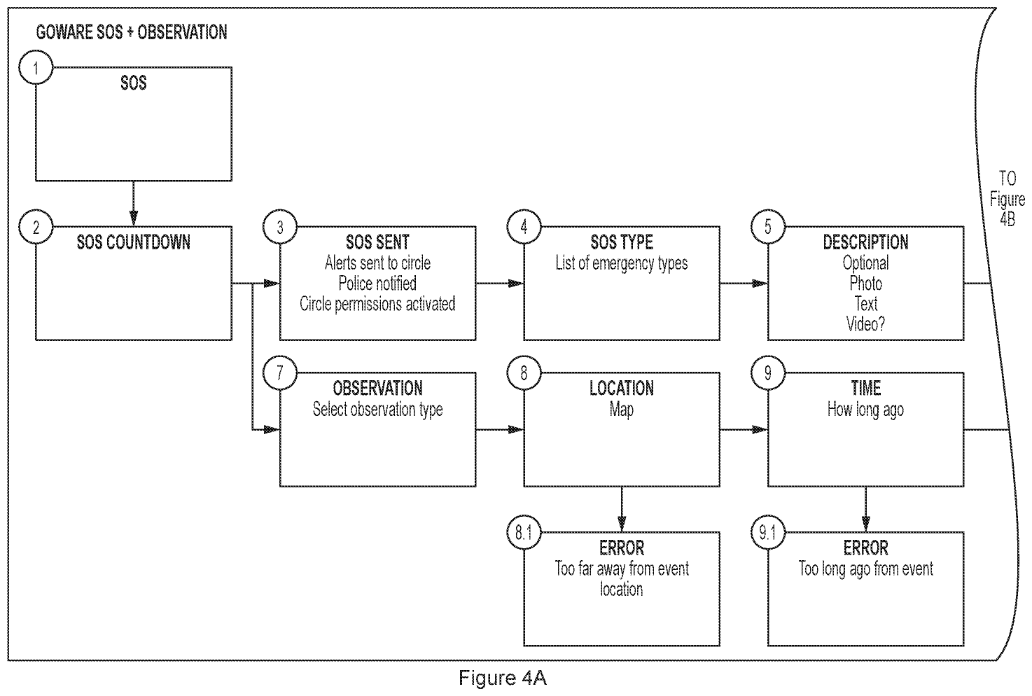

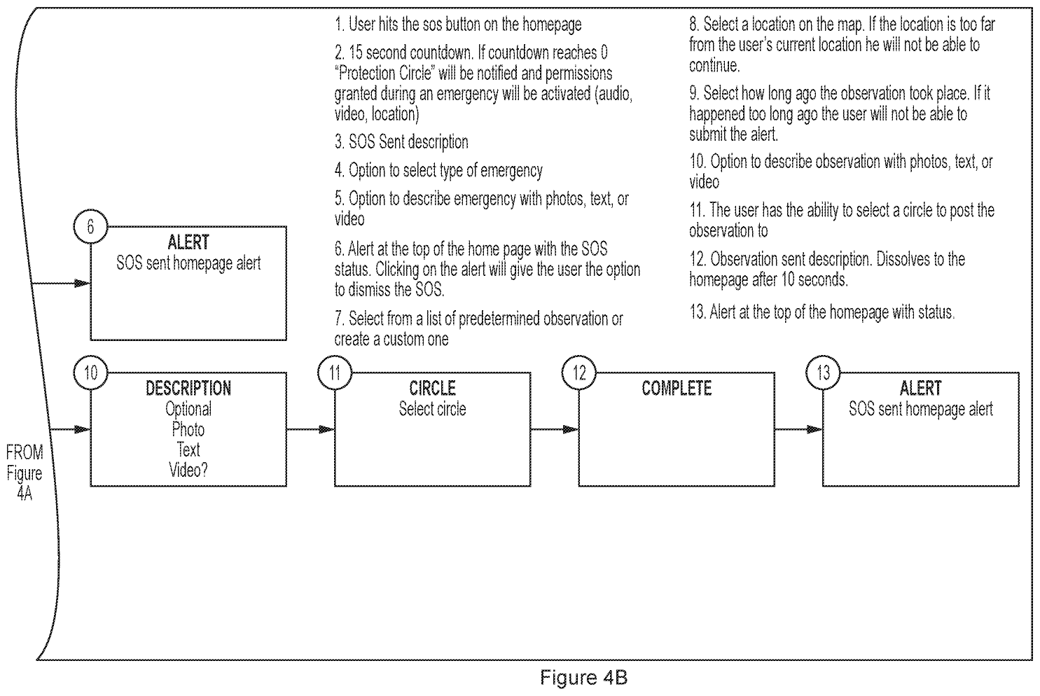

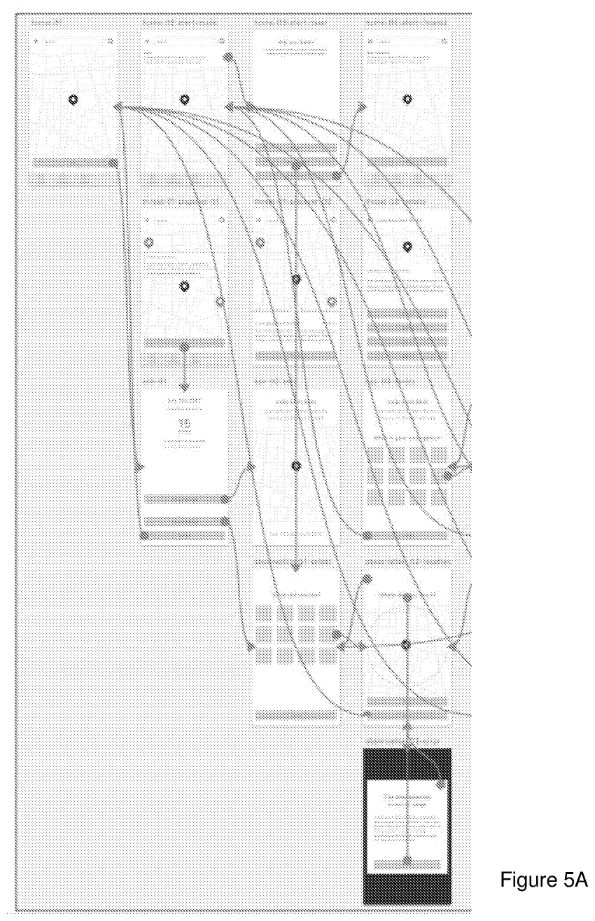

An exemplary process flow for creating an alert that a hazard exists, including defining a hazard geo-location, is shown in FIGS. 4A-4B, and further described below. In addition, FIGS. 5A-5B present one embodiment of a mobile application screen flow for a user interface that allows a user to submit an alert, including defining a hazard geo-location. The user can notify the system of a hazard or alert, and then submit relevant information about the hazard, including textual information, location information, photos, video, and other sensor data. The textual information may include when the hazard began or when it was last viewed, the location of the hazard, description of the hazard, information about bystanders, information about terrain or nearby structures, and so forth. The user can further submit information about with whom the information should be shared, for example, a specific circle of users or contacts. This may include selected users or a predefined group such as other users of the same employer, and so forth.

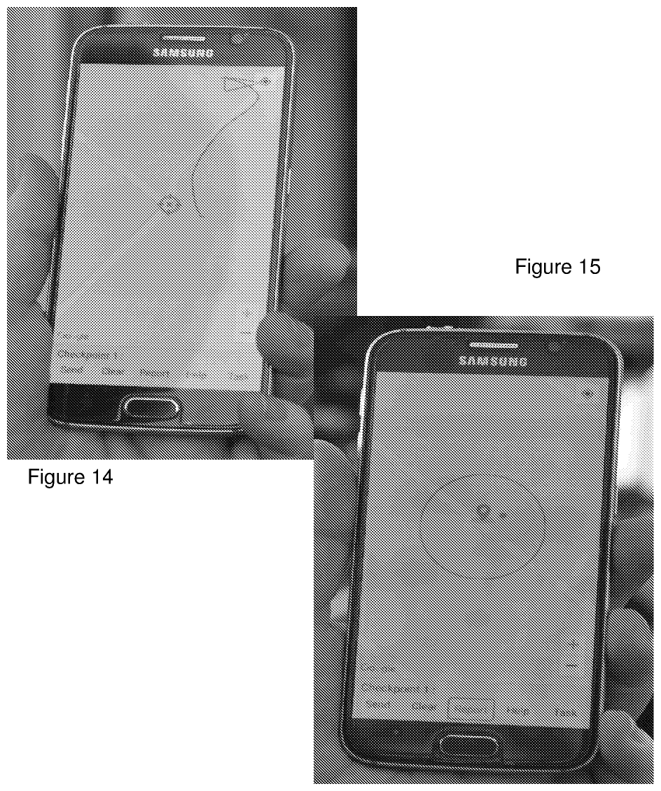

The module is further configured to receive alerts and the included information from each user, where each alert provides information about an abnormal situation and/or a threat scenario including the type of the hazard, the location of the hazard, the severity of the hazard, and so forth. In addition, the alert may also include an image or video of the hazard and/or a “pin” defining the center or approximate location of the hazard or its originating point. It is contemplated that user could also define a radius of the area affected by the hazard using the interface, for example. This may include the user dragging a box or outline of the hazard as an overlay on a map, or could include textual information about the hazard's location or boundaries. An exemplary user interface is shown in FIG. 15.

After receiving the users' inputs, the hazard tagging module is configured to analyze the received data using a processor and predict the reliability of each user's input based on a variety of factors including, for example, user profiles, input corroboration (e.g., whether another user's input is identical or overlapping), input timestamps and repetitiveness, and the user's proximity to the hazard. From this analysis, any discrepancies are noted between users' input until such discrepancies are resolved.

The hazard tagging module may be configured to calculate the reliability of the information provided by the users based on some or all of the following criteria: the location of the hazard, the proximity of the hazard to the user, the visibility of the hazard to the user, the number of users reporting the hazard, the frequency of the reports from users, the timeliness of the report, the accuracy of previous reports by the same user, the details reported by the user (audio/video), and any patterns of repetitiveness by the user.

In addition to user input, the module in some embodiments can be further configured to receive and combine pictures, streaming video from security cameras and drones, sensors and motion detectors in proximity of the hazard, and synthesizes these sources of data to provide mass notification checkpoint-based instructions to the users as well as any supervisors and first responders for public safety.

With this information, it is further contemplated that the module can present the best-known location of the hazard to a user by superimposing a virtual image representing the hazard at the location on a three dimensional version of the site fingerprint on the user's device. The three dimensional site fingerprint includes all physical attributes of the site (such as terrain, walls, shrubs, buildings, car parks, etc.). All on-site users may also be plotted in the three dimensional environment. Thus, the module can be programmed to synthesize all the collected and relevant data, and provide each user with their own unique point of view (POV) of the hazard, looking through structures and features. These three dimensional, augmented reality, POVs can also be made available to the first responders.

In some embodiments, the hazard tagging module is configured to determine the exact location of the hazard by comparing the latitude, longitude, and altitude with the site fingerprint (i.e., detailed digital map of the facility), and create a circular geo-fence illustrating the scale of the hazard. However, the hazard geo-fence needs not be circular; it can be rectangular, elliptical, or any other geometrical shapes or even shapeless boundary. See FIG. 15.

The hazard tagging module is further configured to mark the geo-fenced area on a virtual/digital map, which can then be rendered by the platform and presented map on users' mobile or other computing devices using a combination of GPS, Telematics, and digital sketching technologies. Thus, for example, once a hazard is identified, the hazard can be presented to users via their devices, and preferably as an overlay on a digital map or alternatively as an overlay via augmented reality. Each user or sensor (e.g., camera, etc.) controllable by the system and in line of sight of the hazard provides additional tag/geo-fence input from their specific points of view (POV). Input from the onsite security camera monitoring controller can also be included.

The hazard tagging module is programmed to combine and overlay the hazard perimeter generated from all inputs. Various overlay inputs are processed internally and validated against location specific variables from Geo Fencing, Maps, Triangulation, and others. Areas of overlap are identified as “validated hazard”, whereas areas with no overlap will be identified as “probable hazard”.

Where user input conflicts, the hazard tagging module is configured to automatically take the “conservative” option. For example, if a user's input indicates a specific area is on fire, while another user's input indicates that the area is “clear”, the system will show the area as “probable” on fire. The hazard tagging module will note the discrepancy, and monitor the discrepancy until it is resolved (cleared or confirmed). In such circumstances, it is contemplated that the hazard tagging module may calculate the reliability of the information provided based on some or all of the following criteria: the location of the hazard, proximity of the user, the visibility of the hazard to the user, the number of users reporting, the frequency of the reports from users, timeliness of the report, accuracy of previous reports by same user, and patterns of repetitiveness.

The hazard tagging module is configured to automatically assign checkpoints to one or more users, utilizing a rule-based radius guide, for all “validated” and “probable” hazard locations. This helps ensure the accuracy of the information concerning a hazard through specific requests, which could include specific information at specific locations, for example. Requests to confirm the validity and status of all “probable” hazard locations will automatically be sent to the user onsite.

The hazard tagging module is configured to integrate information of facilities' construction, including the material specifications from the digital CAD or Blue Prints, with navigation and geo-fence technologies. The hazard tagging module is also configured to identify the location of the structural features and construction materials. These materials are classified in the hazard tagging module database according to safety criteria such as fire retardants and ballistic properties.

The hazard tagging module is configured to associate the location and capabilities of these materials to the type and movement of hazard on the site fingerprint (e.g. a large planter can be used as cover from gun fire at a distance of 100 feet or more, etc.). This is accomplished by the hazard tagging module referencing the site fingerprint stored in a secured database of the hazard tagging module, and adjusting/modifying the geo-fence to account for the physical layout of the affected area (e.g., a concrete wall will not burn, and will stop a fire) to leverage location-specific attributes and fingerprints. This ensures the geo-fence of the hazard reflects the hazard's actual shape and dimension. Once modified, the hazard tagging module is preferably configured to automatically transmit this transformed hazard geo-fence information to all site users, and update the geo-fence on the users' devices.

The hazard tagging module is further configured to provide an interface that allows the users to continuously update the situation of the hazard, and continuously process the ongoing input from users. In some embodiments, the hazard tagging module can send frequent checkpoint-based instructions to the users requiring them to confirm the status of the tagged hazard being tracked. This can include detailed descriptions of the hazard based on direct observation following the acronym of S.A.L.U.T.E (Size, Actions, Location, Uniform, Time, Equipment), which could be in the form of video, photos, text messages, emails, as well as social media apps and the “clear” function within the application itself. For example, via the interface, the users do this by simply drawing an arrow with their finger on the mobile computer's screen. See FIG. 14.

It is contemplated that the interface via the module can present the user with the ability to provide additional input from the user, such as the rate of motion of the hazard. This could occur via a prompt by the module to the user's device, for example. Rate of motion options, to describe speed of movement and expansion of the hazards, natural phenomena or individuals, can include, for example, stationary, crawl, walk, jog, run, drive, fly, hover, billow, breeze, windy, very windy, etc. It is preferred that speeds, in miles per hour (MPH) or equivalent scale, are pre-defined for these terms.

By continually processing input from users, the hazard tagging module can identify the most likely or current location of the hazard and predict the direction the hazard is traveling/moving. In the case of a person as a hazard, such further analysis can identify when such person/hazard may change its direction of movement. Utilizing this input, the hazard tagging module is programmed to create a dynamically evolving model of the shape, scope and movement of the hazard, minute by minute.

The hazard tagging module is also programmed to dynamically update the hazard tag/geo-fence to reflect the input and confirmations from all users. The real-time location and movement of the hazard, including its size and shape, is shared with all users in real-time providing an unprecedented level of situational awareness on the go.

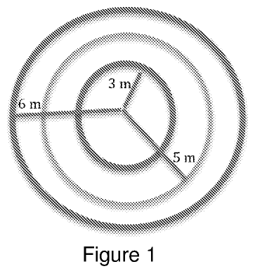

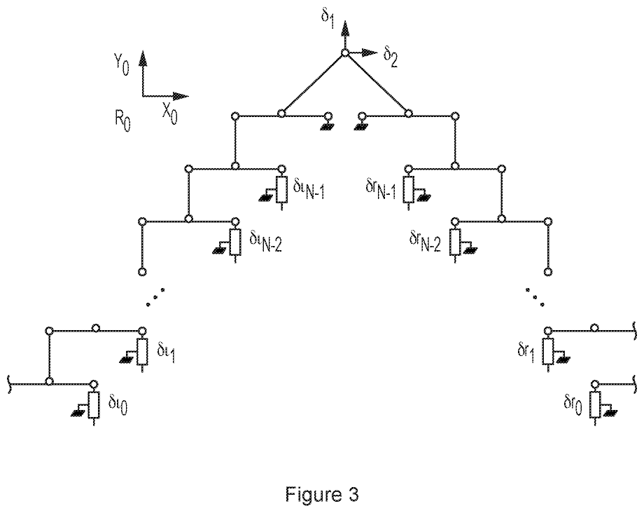

The hazard tagging module is programmed to apply a predefined trajectory algorithm that calculates the rate of motion versus known terrain features and other factors such as accessibility, visibility, obstructions, crowd density, and utilizes a triangulation technique to define the required attributes and exact distance users are from the affected area. Based on this calculation, the module can define multiple zones of danger. For example, as shown in FIG. 1, for a fast-moving hazard such as a suspicious individual, three zones could be identified: High danger, Medium Danger and Low Danger. Contemplated trajectory algorithms defines the optimized path of a moving object, by minimizing (or maximizing) some measure of performance while satisfying a set of constraints. Exemplary logic of a trajectory algorithm is shown in FIG. 3.

These zones of danger are preferably marked and presented based on the radius plotted on pre-defined hazard rules in the system. The zones are distributed based on a radius that can be changed depending on the national security guidelines for disaster management to the geo-fenced area or other rules or regulations, and accounting for physical attributes of the site and the projected rate of hazard movement, expansion and/or shrinkage.

Utilizing this dynamic view of the hazard, the hazard tagging module is programmed to automatically project the time horizon of expansion or movement of the hazard and estimate its future location and time to impact. This projection is made available to the appropriate users, utilizing rule-based communication protocols.

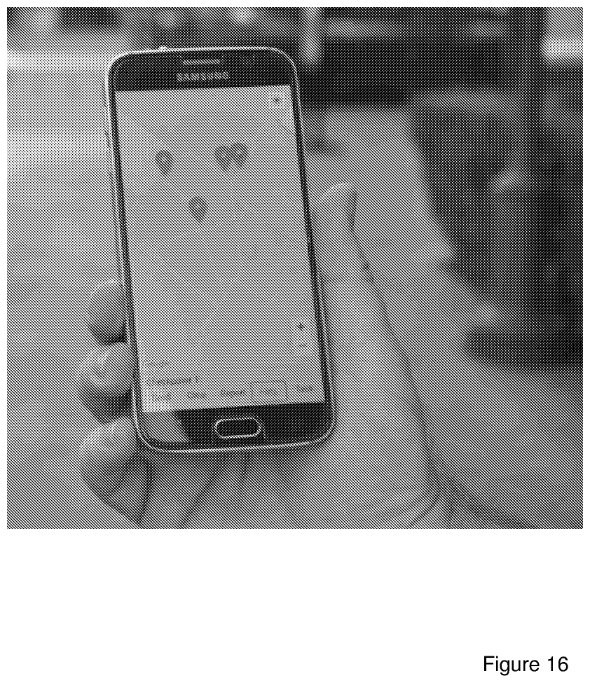

The hazard tagging module further includes a navigation engine that is configured to continuously track the locations of all users by comparing sensor data with site latitude/longitude/altitude and map distance measurements of the site where the user(s) are located. By merging all user input, in real-time, the hazard tagging module is able to calculate and show the correct direction of users' movement. If authorized, the hazard tracking module can present users with the location of nearby users. An example of this is shown in FIG. 16 where other users may be presented on the interface (here, as pins).

### Example 2: Immediate Life-Threatening Dynamic Hazard—e.g., Active Shooter

In the case of a hazard identified by onsite users as a dynamic threat like an active shooter or bomber, the hazard tagging module is programmed to provide an interface to receive an alert from all onsite users (such as security personnel, site management, and with restrictions, safety-minded general public) that are impacted by the hazard or in line of sight of the hazard, and from a verified external source like public safety announcements and mass notifications from local, state and federal law enforcement and public safety (e.g., “Amber Alert”, etc.).

Once an alert is received, the hazard tagging module is programmed to immediately send the hazard information to all the users at the site, as well as to site management and first responder communities, as defined in the rules-based mass notification program. This will be accomplished via API and function calls to various systems of the module as needed to enhance productivity, collaboration, and safety of the individuals involved.

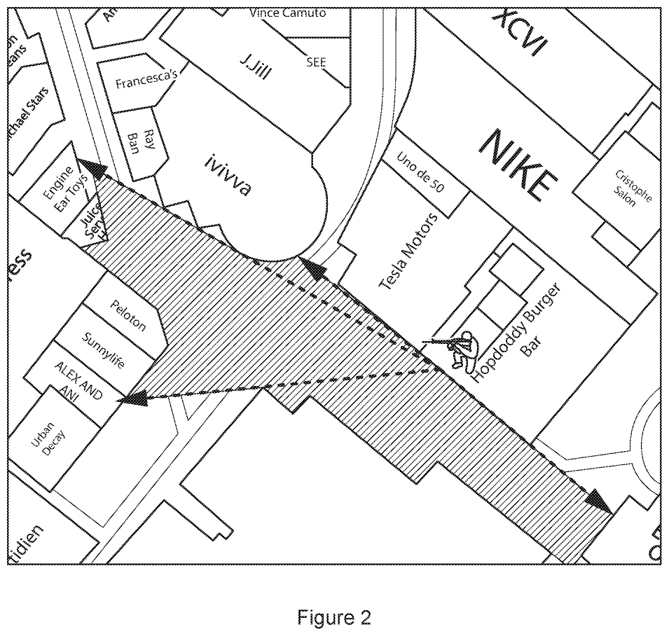

The hazard tagging module is programmed to receive, compare and correlate ongoing hazard-tagging/geo-fencing input from all users who have line-of-sight of the hazard. Each input will describe the hazard geo-fence from a different angle. The line of sight/line of fire of the shooter is assessed by the hazard tagging module in relation to the shooter's location and the ballistic properties of the construction materials that exist at the structure site is made from. See FIG. 2 illustrating an example of the line-of-fire Hazard Geo-Fencing generated by the module.

As with all hazards, the hazard tagging module is programmed to combine and overlay the hazard impact radius perimeter generated as a result of each user input. Various overlay inputs are processed internally and validated against location specific variables from Geo Fencing, Maps, Triangulation, and others. Areas of overlap will be identified as “validated hazard”, whereas areas with no overlap will be identified as “probable hazard”. The hazard tagging module is programmed to then assign checkpoints for all “validated” and “probable” hazard locations.

Due to the urgency of these scenarios, requests to confirm the status of all “probable” locations will automatically be sent to all users onsite with high frequency. In a “high frequency” scenario, the system will send a prompt every sixty seconds. For “low frequency” scenarios, the system will send a prompt every three minutes. High frequency input from the users will accelerate the confirmation of locations rendered safe, and enable the rapid narrowing of the hazard perimeter. This is accomplished using internal rule-based mass notification services built into the system algorithm.

The hazard tagging module is programmed to identify safe areas out of the range of the shooter and indicate to the user objects or structures that could be use as cover in the immediate vicinity. The hazard tagging module automatically accomplishes this by using location-specific variables from geo-fencing, the site fingerprint and geo-locations, triangulation, and the database of facilities construction.

As discussed above, user input can include simply drawing an arrow with their finger on the mobile computer's screen to identify a direction of a hazard. An example of such input is shown in FIG. 14. In such cases, the hazard tagging module is preferably configured to overlay this directional arrow on the site fingerprint, and translate the arrow into coordinates (e.g., starting point, direction and turns, etc.), thereby enabling the analog input to be fully utilized in the hazard tracking function. The system may then automatically estimate the geo-destination arrival time, and send an alert regarding the estimated time of arrival (ETA) of the suspicious individual or vehicle to all the users at the site.

The hazard tagging module may be further configured to apply the trajectory algorithm (direction and speed of movement) to the site fingerprint, and project the probable location of the suspicious individual within specific timeframes. This is accomplished via predictive analytics combining input from users, sensors and cameras then calculating the rate of motion versus terrain features and other factors such as maneuverability, accessibility, visibility, obstructions, crowd density and based on the site layout, site fingerprint, and using all known paths. It is contemplated that the initial training of the module will be storing all the coordinates for the entire site. When the suspicious individual travels, the directional mapping would be developed based on the route the individual is travelling. The hazard tagging module is programmed to send the suspicious individual's predictive route to all the users who are authorized to receive such information.

It is further contemplated that the movement and whereabouts of all users onsite may be made visible to the first responders and area commander or site managers with authorized access, providing them with a Common Operational Picture (COP) and allowing them to track crowd flow and anticipate bottlenecks congestions and better understand other mass gathering areas dynamics.

In order to seamlessly share hazard-tagging/geo-fencing information with first responders and public safety community, the hazard tagging module includes a secure, bi-directional, portal that enables the timely flow of critical relevant information from various approved sources. Vetted information will be uploaded to the system database and incorporated into the hazard perimeter protection and security upgrade process, as well as post-incident situation reports.

As with a stationary or slow moving hazard, the module can be programmed to superimpose a virtual image representing the hazard as a suspicious person at the precise location on a 3D version of the site fingerprint on the user's device. This can be seen in FIG. 2. The module may then apply the trajectory algorithm (direction and speed of movement) as described above to the site fingerprint and projects the probable location of the suspicious individual within specific timeframes. This is accomplished via machine learning predictive analytics based on the site map layout, site fingerprint, walking paths and the areas where the suspicious person could go. It is contemplated that the initial training of the system application will comprise storing all the coordinates for the entire site. While the suspicious person moves, the directional trajectory is forecasted based on the route and site information like doors, hallways, intersections, etc. Other information such as user updates, as well as input from sensors, security cameras, etc., can be used to continually update the trajectory algorithm. A user's interface can continually be updated to augment the user's POV with the suspicious individual's predictive route and location as an avatar to aid in navigating carefully to converge on the intercept point, from different directions.

### Dynamic Routing & Resourcing Module

The system can further include a dynamic routing and resourcing module that is configured to (1) merge navigation and tracking technologies with workforce scheduling and financial analysis according to an evolution of an incident, to (2) randomize and coordinate the routing of users, and (3) to deploy personnel and allocate resources in relevance to the user's evolving circumstances and needs.

The dynamic routing & resourcing module is programmed to continuously track each user's location, assess movement in relation to the other users, and compare this information to the location and movement of hazards. In this manner, the dynamic routing and resourcing module is configured to guide users toward, or away from, hazards and other users via the safest route of approach or evacuation.

The dynamic routing and resourcing module is further configured to assess the Service Level Agreement (SLA), the then-current threat level, the Resource Manager, and the Dynamic Routing Module, and create a fully randomized, but coordinated, routing plan for each user on a given schedule. Thus, for example, for private security, the module can create randomized routes for each officer that retain an overall plan and ensure the officers interact with specific check points during patrols, for example.

Such routing is achieved by using various data structure-based algorithms and APIs which will dynamically provide real-time routing using RSSI-based algorithms. The routing can be further enhanced by combining trilateration (the process of determining absolute or relative locations of points by measurement of distances, using the geometry of circles, spheres or triangles), multi-lateration (a navigation technique based on the measurement of the difference in distance to two stations at known locations that broadcast signals at known times), and triangulation (the process of determining the location of a point by forming triangles to it from known points) along with Beacon or other WiFi devices.

The dynamic routing and resourcing module is configured to compare the routes of all users in real-time and provide users with routing instructions that increase or decrease overlapping of users' routes at similar times. Thus, two users may have an overlap in their routes, but they will reach the overlapping portion at different times during a patrol, for example. Route randomization is calculated by the module, which analyzes all identified checkpoints and correlates the history of previous users on the same routes (including past incident locations and frequencies). Users are then provided with routing instructions that are different from the routing instructions provided to previous users for the same site and time. This helps to systematically eliminate predictability, while providing maximum coverage and redundancy, and with optimal efficiency.

The dynamic routing and resourcing module is further configured to create a cost model for the route plan, which includes scenarios for increased and/or decreased threat levels, and ensures that the route plan falls within the parameters of the SLA. This is accomplished using APIs and Data Structures based algorithms like Cycle-Canceling Algorithm, Successive, Shortest Path Algorithm and Primal-Dual Algorithm. Combined, these complex algorithms provide intelligence to the solution supporting predictive analysis.

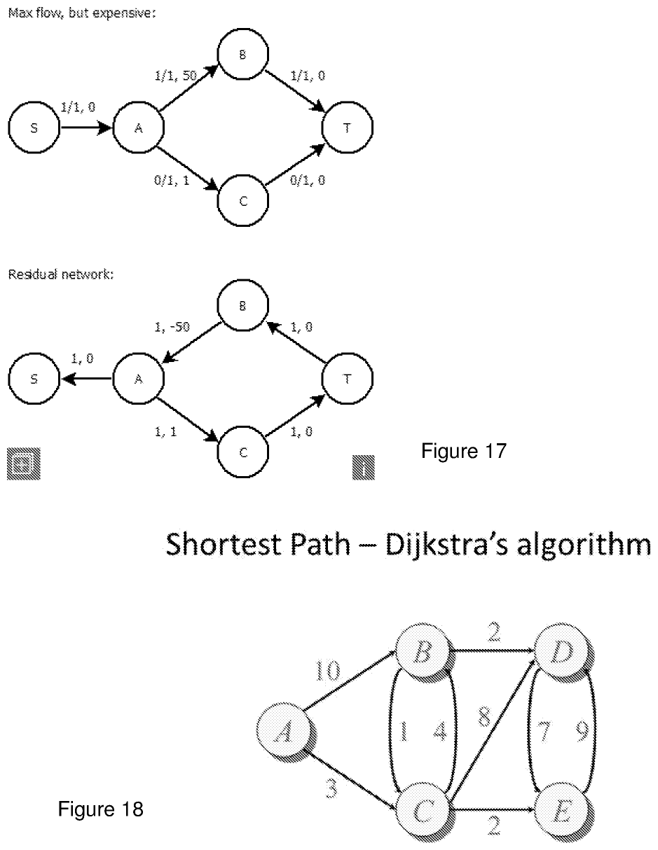

For example, the Cycle-Canceling Algorithm calculates a minimum-cost flow on a given site map. Based on the number of security touch points, and level of threat, the module using this algorithm can compute how to route/flow patrollers through a site using a minimum-cost flow and without violating any constraints. An exemplary outline of the cycle cancelling algorithm is shown in FIG. 17.

The successive shortest path algorithm searches for the maximum flow and optimizes the objective function simultaneously. Using this algorithm, the module is able to solve the so-called max-flow-min-cost problem. An example of this is shown in FIG. 18, and could involve finding the shortest path to patrol for a maximum flow or minimum use of resources while using automated robots or drones to patrol a specific route on the site map instead of simply roaming around.

The primal dual algorithm provides for the ability to solve a problem with numerical complexity in linear programming, by repeatedly solving a problem which has only “combinatorial” complexity. This concept is proven and frequently encountered in combinatorial optimization. For example, if there is a feasible primal solution “x” and a feasible dual solution “y”, then both are optimal solutions. The primal-dual algorithm generates such a pair of solutions. An outline of the algorithm is shown in FIG. 7.

The unique combination of these algorithms, enables the module and system to allocate, route, and reallocate resources in an extremely efficient manner, especially during emergency situations where threat levels are adjusted (increased or decreased) as appropriate.

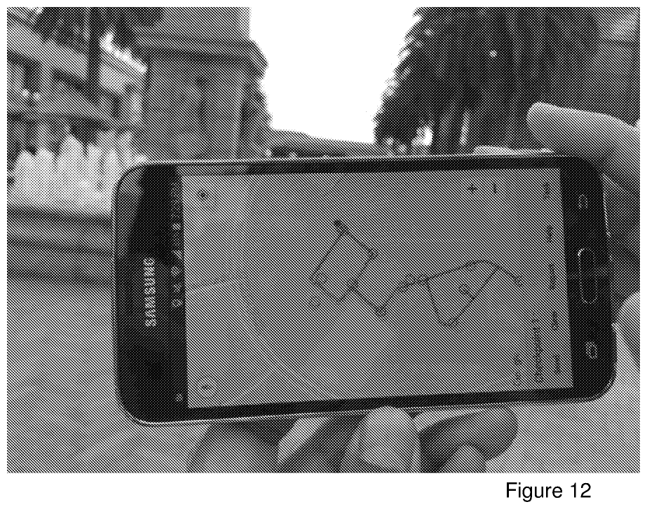

Following the user authentication, the system can provide specific route guidance to each user according to the chosen destination or the designated patrol shift selected. Users are also updated of any incidents or hazards that occurred or currently are occurring on their selected/designated route. An exemplary interface showing a randomized route for a user is shown in FIG. 12.

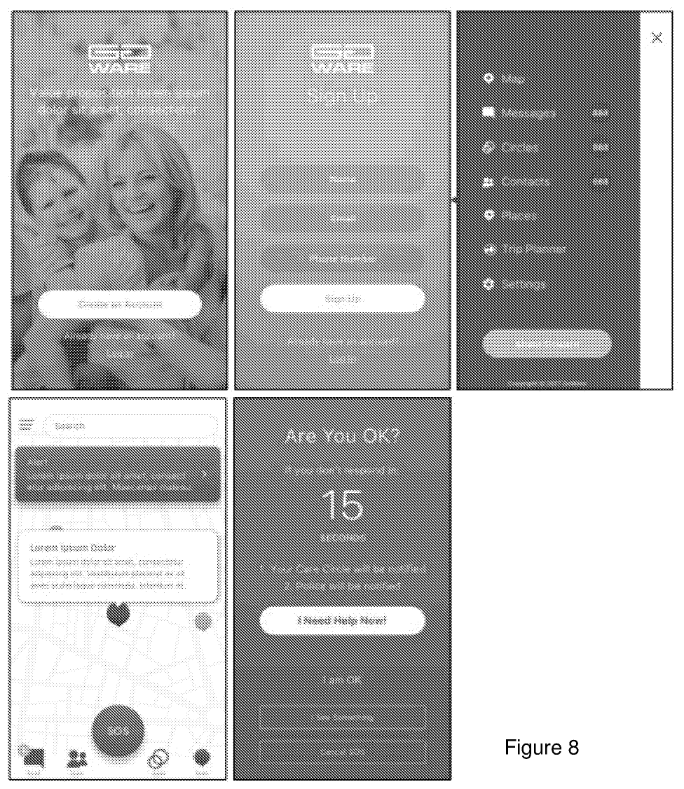

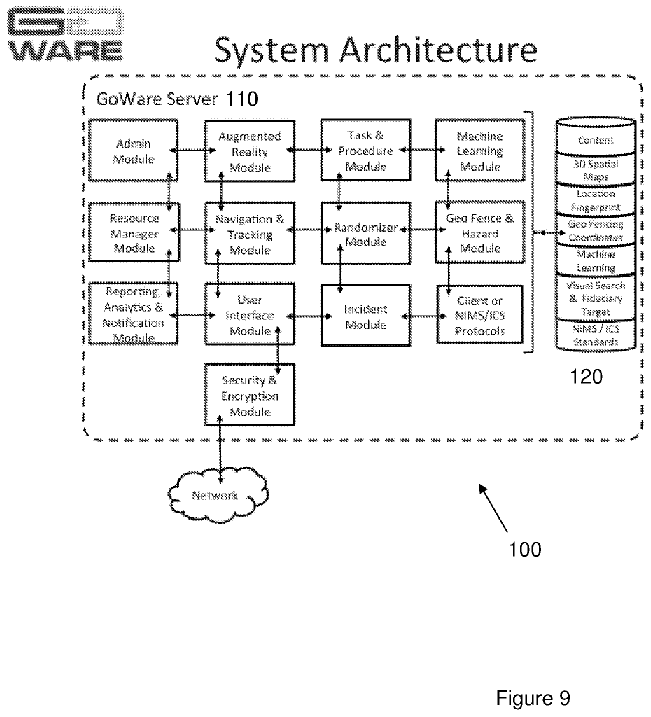

The dynamic routing and resourcing module is programmed to compare each user's activity metrics, at the checkpoint-to-checkpoint level, with the historical files of all previous users and routes. By comparing the tracking data for the current user to the designated routing schedule and the rate of movement of previous users on the same route and time, the system can identify any anomalies or deviations. For example, the system can be configured such that any deviation beyond 15% (e.g., 15% behind schedule or a deviation from the route by more than 15%) will result in the dynamic routing and resourcing module sending an automatic notification of variance to the user and prompts the user to report their status. See right-most screen in FIG. 8, for example. A lack of response and failure to acknowledge and clear the route variance (such as if the user is off-line or otherwise unable to respond) will result in immediate escalation and triggers an automatic notification. The dynamic routing and resourcing module is programmed to send an alert notification to the user's management and to other users onsite. This is achieved using B-Tree based algorithms which will help in fault calculation and deviations.

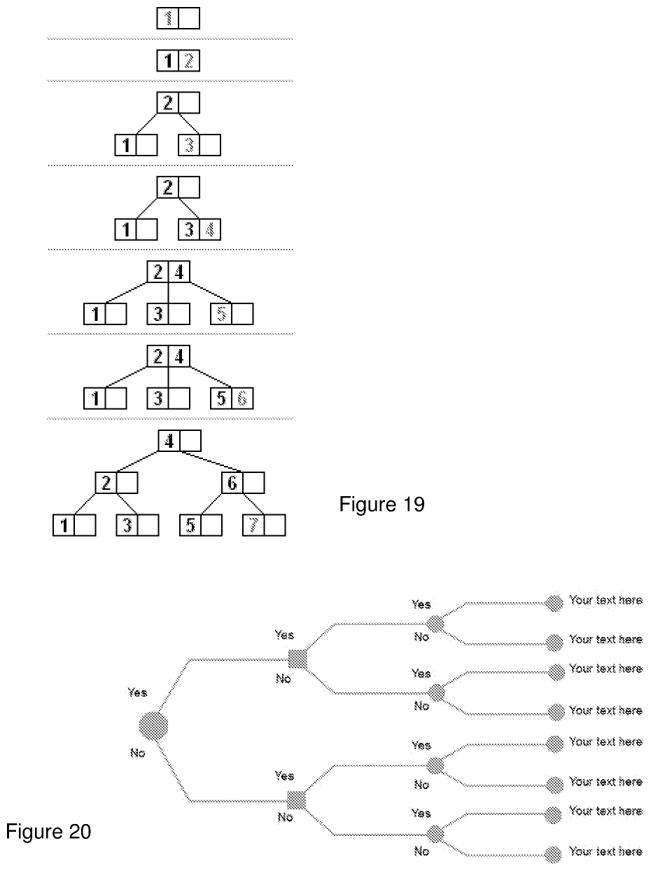

B-Tree based algorithms are constructed as a self-balancing tree data structure that keeps data sorted and allows searches, sequential access, insertions, and deletions in logarithmic time. A B-Tree insertion example is shown in FIG. 19 with each iteration. The nodes of this B tree have at most 3 children.

The dynamic routing and resourcing module then calculates the last known location of the unresponsive user. By comparing the current user tracking data to the designated routing schedule and to the rate of movement of the user and previous users on the same route, time and conditions, the system estimates the range the user may have traveled from the last-known location. The predictive artificial intelligence (AI)-based engine will define and initiate actions based on the last known activity and location. This is achieved using API's and AI frameworks.

With the estimated range, the routing and resourcing module can then automatically identify the locations of other users on-site, reconfigure their routes to converge on the area where the unresponsive user is predicted to be, and send revised route guidance for cautious interception, while at the same time re-routing some of the users to maintain the necessary coverage of critical areas within the site as a result of the unresponsive user and the users sent to find that user. This uses the API's and Data Structures based algorithms like Cycle-Canceling Algorithm, Successive, Shortest Path Algorithm and Primal-Dual Algorithm.

As incidents and hazards are reported to the routing and resourcing module by the users, the module is programmed to automatically update resource requirements and user routing as needed to respond to the incidents/hazards. This preferably occurs by analyzing large data sets and Hadoop for calculations (such as on crowd data or data provided by user consent/providers/other data vendors). This advantageously allows data from other sources to be analyzed by the module where such data could have an effect on an incident.

Upon receiving an alert of an anomalous situation, such as a fire or other hazard or incident, the routing and resourcing module automatically assesses the scope of the hazard via a processor, compares the potential needs at the hazard location against the skills and experience of the on-site users, and reconfigures routes of selected users to provide optimal support for the situation. In some embodiments, the dynamic routing and resourcing module is programmed to guide some users toward the hazard location to provide immediate support, while also assigning some users for crowd control and/or evacuation roles. The dynamic assignment engine conducts the analysis based on algorithms to predict the closest available and accessible user support, as well as each users training and abilities. This is accomplished using the framework and API based on preloaded algorithms.

The movement and whereabouts of all users onsite can be made visible to the first responder and area/incident commanders/facility managers allowing them to track crowd flow in real-time and anticipate bottle necks, congestions, and other mass gathering areas dynamics. This real-time situational awareness expedites and improves the coordination and deployment of emergency resources and personnel to the areas where and when they are needed most.

The dynamic routing and resourcing module is programmed to assess the scale of the unexpected anomalous occurrence, and compare it to the SLA, and using the Rules-Based threat-level to define needed additional resources (e.g., human, equipment and materials) and calculate anticipated cost changes to respond and mitigate, as well as the subsequent costs. The “rules-based threat-level” describes the pre-defined levels of workforce coverage to deliver optimal service performance in each particular circumstance considering multiple potential scenarios. Each threat scenario, coverage, and resource requirements are quantified and pre-approved enabling sustainable support of rapidly evolving/escalating events. For example, a fire will be managed by the local fire authority, with limited resource requirement from the onsite users. Whereas, a confirmed terrorist threat may require increased vigilance, increased checkpoints, and increased number of security staff, resulting in increased costs. The dynamic routing & resourcing module is programmed to automatically send the incident summary and revised plan to the appropriate management/authority for approval, and securing of the required resources. This is achieved using Workflow engines and API's for approvals routing and tracking. The rules engine will be based on the big data and predictive analysis tool and framework.

### Quality Control & Machine Learning Module

The systems/methods contemplated herein can further include a quality control and machine learning module that combines site-specific instructions and path-of-least-resistance logic with databases of Lessons Learned and digital signatures from past users. The quality control and machine learning module is preferably programmed to deliver relevant guidance to optimize delivery and quality of service. The quality control and machine learning module can be configured to compare each user's service performance history against other users' performance at the same locations, routes and/or times. The quality control and machine learning module can be configured to assess the performance deviations associated with each user. Furthermore, the quality control and machine learning module can be configured to automatically provide the user with corrective instructions in real time to improve competency and send recommendations for process improvement to management.

Every patrol officer can encounter an anomaly, at any time, within their area of operation (AO) or assigned route. In the event of an emergency, patrol officers (e.g., users) may be faced with unpredictable situations and have limited time and resources to mitigate hazards.

As such, users may need to deviate from their designated route and their assigned tasks in response to unexpected circumstances. Since the whereabouts of all users can be continuously tracked, route deviations can be recorded by the quality control and machine learning module. With this information, the module can thereby provide for system training on the path coordinates. Once checkpoints are defined for a site, the quality control and machine learning module can be trained by the user traversing the desired route/path and pressing “Clear” or a similar function at each checkpoint. This will help the module understand the paths taken, the time required, and any deviations that may occur to help plan future routes and scheduling. Data from every training exercise, walkthrough and patrol is recorded and tracked by the system. Input from other mediums such as beacons, sensors, fiduciary targets, RFID, and cameras, would also be tracked. This data is then used in machine learning algorithms to optimize the site fingerprints, route, and checkpoints. This data becomes valuable not only for every user but could also be used for drones future use on the same route.

The quality control and machine learning module is preferably configured to identify any deviation from the statistical norm, and send requests to the appropriate users to identify the reasons for the deviation, which can be reported and—displayed on the Dashboards. These deviations will also account for auto-correcting/self-learning wherein the system will send prompts to the user when deviations occur on the route. Any deviation beyond 15% or other appropriate measure deemed desirable will result in the automatic notification of variance sent to the user by the quality control and machine learning module. Failure to “clear” the variance will result in immediate escalation and notification being sent to management by the quality control and machine learning module.

Real-time access to this information will significantly enhance user safety and can help avoid hazards or anomalies. The quality control and machine learning module will use the combination of location fingerprints, navigation engine, checkpoint data, and B-Tree based algorithms, to help in fault calculation and deviations, in order to accomplish this.

Using performance analytics, the quality control and machine learning module is configured to compare metrics from all past out-of-the-ordinary occurrences and considers all previous outcomes to project the most appropriate course of action including any necessary rerouting. The quality control and machine learning module is programmed to send revised routing guidance and recommendations for course-of-action to the users onsite. This will be accomplished using predictive analysis' API and frameworks methodology, which enables machine learning.

The comparative data is stored and the system produces reports and analysis of each occurrence for continuous improvement and optimization of future service delivery. New routing and user instructions are developed by the system considering historical scenarios. The machine learning and AI capabilities for the framework will enable this by using algorithms based on decision trees, k-nearest neighbor, etc.

A decision tree is a decision support tool that uses a tree-like graph or model of decisions and their possible consequences, including chance event outcomes, resource costs, and utility. An example of a decision tree is shown in FIG. 20.

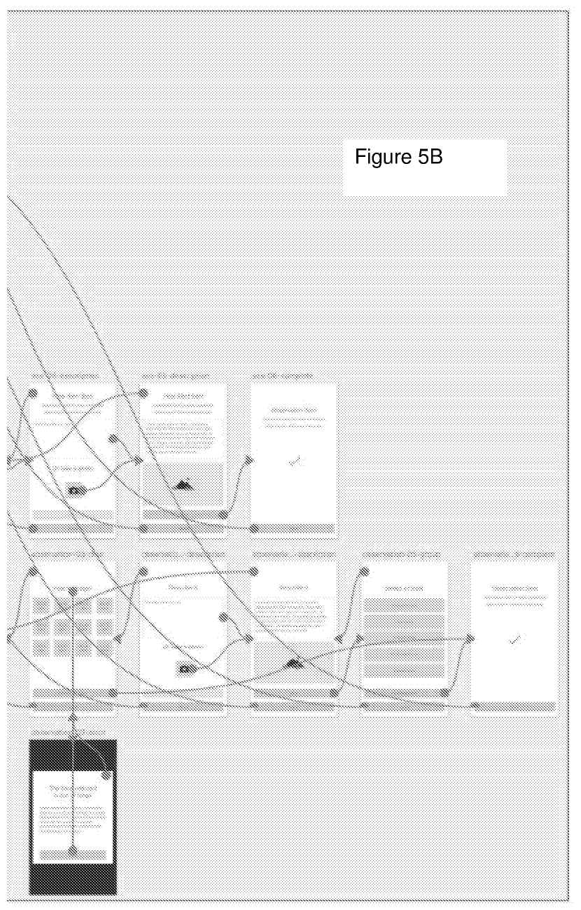

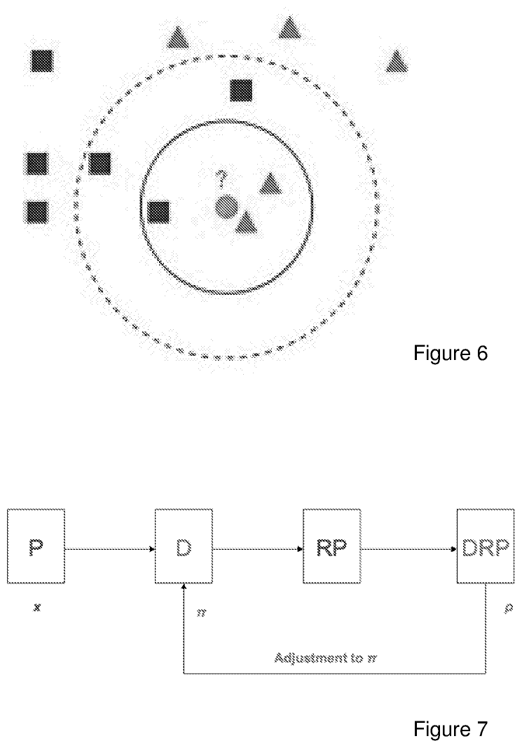

An example of a k-nearest neighbor classification is shown in FIG. 6. The test sample (green circle) should be classified either to the first class of blue squares or to the second class of red triangles. If k=3 (solid line circle) the test sample is assigned to the second class because there are two triangles and only one square inside the inner circle. If k=5 (dashed line circle) the test sample is assigned to the first class (three squares compared with two triangles inside the outer circle).

Drawing on the site fingerprint, as well as the extensive data in the incident database, the quality control and machine learning module supports Incident Forensics, including complete AR visualizations and replay.

When a user, or one of the modules within the system, identifies a specific location of interest, or a route, the Augmented Reality Intercept module automatically searches through all the various available databases (including, but not limited to; site digital fingerprint, database of all past incidents at the specific location, database of all past hazards, database of current threat level, etc.) and correlates the data with the navigation, tracking, tagging and geo-fencing functions to identify high risk areas as Hot Spots.

The Augmented Reality Intercept module identifies any Hot Spots and renders them on the site fingerprint in three dimensions (e.g., a sphere with x, y & z dimensions). Extra care, or avoid notices are automatically generated by the Augmented Reality Intercept module, dependent on the user's context, providing the basis for pro-active decision-making enabling the reduction of risk.

In the case of a guard or service personnel receiving a complex dispatch instruction or task, the Augmented Reality Intercept module will provide the user with specific geo-location-based visual guidance in the form of an augmented reality overlay. The user views the precise checkpoint location through their mobile, or wearable, device and the instructions are superimposed on the image, providing exact guidelines. Before the task is begun, the user will save a screenshot of the view including the state of the checkpoint as well as the superimposed AR guidance. Upon task completion, the user saves another screen shot. This process will ensure new heights of quality and reliability of guard-assigned tasks.

When the Augmented Reality Intercept module receives notification of a hazard or incident from the users, it will correlate all user geospatial input considering: source reliability, frequency and time-stamp of input, and user proximity. The Augmented Reality Intercept module will then merge user input with input from on-site cameras and sensors to establish a three dimensional geo-fence of the incident. The proprietary algorithms will yield a geo-fence that defines, with a high degree of certainty, the nature, scope and scale, as well as movement speed and direction of the hazard.

The Augmented Reality Intercept module creates an avatar/icon-based representation of the hazard, and superimposes the hazard on the site fingerprint. The Augmented Reality Intercept module also creates a digital rendering of a Virtual Hazard and sends this real-time AR overlay to authorized affected users, so they can “see the hazard”, and its' movement, through any structures that may be between the user and the hazard. The Augmented Reality Intercept module merges the real-time user geo-location with the real-time hazard geo-location, and creates a specific point of view (POV) for each user, reflecting their line of sight, including intercept, shelter, evacuation or reunification guidance.

After the user completes all their assigned instructions, and the incident is closed, the Augmented Reality Intercept module creates an Incident Forensic File. By recalling the recorded database captured during the incident, the Augmented Reality Intercept module provides a step-by-step virtual reality recreation of events and timelines, almost immediately. This forensic replay confirms the exact timeline evolution of the hazard, as well as documents the time-phased user knowledge and decision-making of all users involved.

The Augmented Reality Intercept module also creates and provides an AR re-enactment of the incident evolution, on-site—at the specific location illustrating the Lessons Learned and supporting incident analysis and recommendations for improvements.

Through these processes, physical posture is upgraded, real-time responsiveness is improved, training is enhanced, and liabilities are mitigated.

The above scenario demonstrates the functionality of the Augmented Reality Intercept module from the perspective of a security guard and service personnel. However, it is important to note that the Augmented Reality Intercept module also supports the general public who can “sign-in” and provide input on incidents, hazards, or points of interest. The Augmented Reality Intercept module is a platform that supports multiple use-cases with real-time, real-world, visual guidance.

With the volume of public users, the Augmented Reality Intercept module will enable AR/VR forensic analysis of crowd dynamics during a hazardous incident, which will help improve facility design and procedures development.

### Dynamic Incident Management

Coordination and timeliness of incident management and control are crucial to the effective response to, and mitigation of, large-scale incidents. The US Government (DHS & FEMA) have developed and published specific guidelines to effectively transition incident command and control to the most appropriate organization. These comprehensive guidelines, processes and protocols are part of the Incident Command System (ICS) and National Incident Management System (NIMS). ICS/NIMS resolves operational and jurisdictional issues that often inhibit the effectiveness of incident management efforts by pre-defining all the roles, responsibilities, processes and protocols, including access and management of resources. ICS/NIMS access and training is available to any person or organization interested in developing these capabilities and adhering to the ICS/NIMS guidelines.

In order to reduce and/or eliminate the financial liability for acts of terror, the Government has published the SAFETY Act that essentially transfers financial liability to the Federal Government. However, for organizations to take advantage of the SAFETY Act they must implement certain guidelines and adhere to specific policies and protocols. Deploying ICS/NIMS fulfills these requirements.

Unfortunately, few organizations have the subject matter knowledge and experience to effectively implement ICS/NIMS. As a result, broad adoption of ICS/NIMS is limited to the First Responder community.

However, the systems and methods described herein provide for an advanced software system that addresses the current and future emergency management needs in the security industry, and provides easy access to, and deployment of, ICS/NIMS. Such systems can include a dynamic incident management module that merges navigation and tracking technologies with site-specific spatial orientation and Rule-Based policies databases to deliver instructions and organizational guidance to users during emergencies and supports best practices according to national and industry safety standards. It delivers the “who, what, and how to” instructions and regulatory guidance to improve mitigation and resolution of out-of-the-ordinary occurrences.

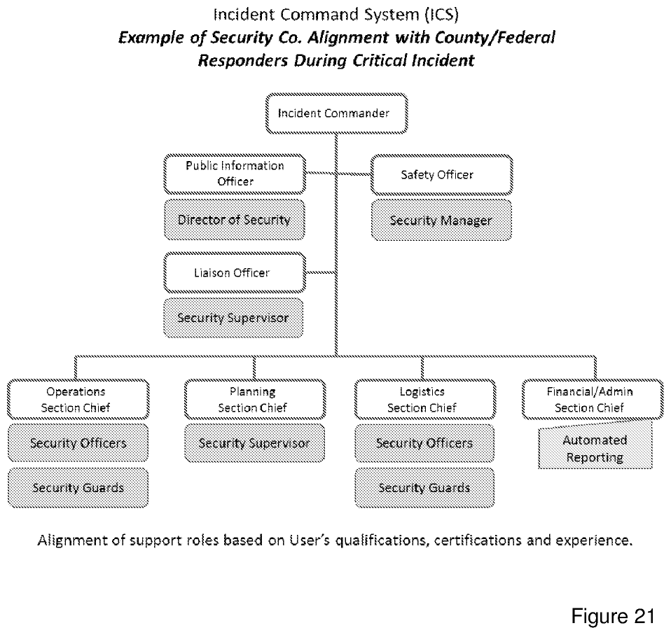

The dynamic incident management module helps establish organizational resiliency in accordance with the highest government standards. The user's location and qualifications serve as the basis for the allocation of roles and responsibilities during incidents and emergencies. For example, FIG. 21 illustrates an organizational structure that maps defined roles in the system with the ICS. The non-shaded items represent roles in the ICS, while the shaded items represent the corresponding roles of an example private security company. In this manner, the processes required by the governmental regulations can be followed. The dynamic incident management module automatically initiates this organizational/role re-mapping process, enabling the seamless transition of responsibilities, while maintaining the highest level of site awareness and knowledge.

When ICS/NIMS is activated, the dynamic incident management module is programmed to calculate the proximity and accessibility of users to tagged hazards and match each user's credentials and experience to these hazards. The allocation logic checks the users' profiles and matches the nearest person with exact skills. The dynamic incident management module is programmed to assign roles and responsibilities to each user in accordance to ICS/NIMS guidelines and track the movement and performance of each user at the incident site. The auto tracking movements uses the predictive analysis's API and frameworks methodology that enables machine learning. The user follows the menu prompts to complete each task and perform their duty as authorized and according to ICS/NIMS protocols. The dynamic incident management module is programmed to monitor the incident and record actions taken by users and coordinates all users in compliance with the ICS/NIMS framework. The predictive analysis's API and frameworks methodology enables machine learning.

The dynamic incident management module is programmed to keep track of resources and personnel deployed in support of the Logistics and Planning functions of ICS/NIMS. By tracking all users, the incident command and compliance module is also programmed to provide real-time situational awareness to the Incident Commander and support the function of the Safety Officer. The planning Algorithm used b-tree and other data structures based algorithm to achieve the awareness.

In the event of extended duration emergency, the dynamic incident management module is programmed to produce situation reports to support the seamless transfer of authority from one command structure to the next and maintain continuity of operations and documentation throughout. The dynamic incident management module is programmed to capture every detail of the operation and provides authorized stakeholders with the ability to monitor the situation offsite using their phone as a Virtual Mobile Command Center. The dynamic incident management module uses predictive analysis and Bi based data analysis algorithms. The incident management module is programmed to produce reports and analysis of the incident and its mitigation at the conclusion of each incident. The Dashboards, based on Big Data and BI bases analytic reports, will provide the analytic data for the incident and its mitigation. The Analytics and Reporting engine produces all such reports.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

1-32. (canceled)

33. A method of identifying and tracking a hazard in a defined perimeter, comprising:
providing access to a site database comprising a fingerprint (map) for each of a plurality of sites, wherein the fingerprint includes at least one of terrain, buildings and structures, properties of building materials, fences, walls, vegetation, and car parks;
receiving information about a hazard at a site from a user;
receiving information about a hazard at a site from a plurality of sensors;
using a processor, retrieving a stored site fingerprint of that site, and analyzing the information about the hazard, the location of the user, and the site fingerprint to generate a three dimensional geo-fence of the hazard at the site;
presenting the three dimensional geo-fence to the user on an interface on a mobile computing device of the user, wherein the geo-fence is presented as an augmented reality overlay such that the user can view the location and size of the hazard using the interface;
receiving updated information about the hazard,
adjusting a size or shape of the three dimensional geo-fence based on the updated information; and
automatically updating the overlay of the geo-fence on the device of the user.

34. The method of claim 33, wherein the overlay further comprises a location of a checkpoint and instructions to the user in response to the hazard.

35. The method of claim 33, wherein the step of generating the three dimensional geo-fence further comprises merging information from the user with data from one or more sensors at the site.

36. The method of claim 33, wherein the step of presenting the geo-fence to the user further comprises merging the location of the user with the location of the hazard to generate a user-specific point of view on the device for the user that utilizes the site fingerprint to provide the user a line of sight of the hazard using the device, and further comprising presenting instruction on the device that comprise route for avoidance or interception of the hazard.

37. The method of claim 36, wherein the interface using the augmented reality overlay is configured to allow the user to view on the device a rendering of the hazard through a structure between the user and the hazard.

38. The method of claim 33, wherein the information about the hazard at the site from the user comprises sensor data from the mobile computing device of the user.

39. The method of claim 33, wherein the information about the hazard at the site from the user comprises a marking of a specific location by the user on the site fingerprint.

40. The method of claim 39, wherein the marking comprises a pin that estimates a location of the hazard.

41. The method of claim 39, wherein the marking comprises a directional arrow that estimates a direction the hazard is moving.

42. The method of claim 33, further comprising receiving information about the hazard from a plurality of sources, and predicting a reliability of the information received from each source by analyzing the received data using a processor to determine a corroboration of the received information by another source, a timeliness of the received information, a proximity of the source to the hazard, a visibility of the hazard by the source, a number of sources reporting the hazard, a type of source reporting the hazard, a granularity of details reported about the hazard, a frequency of reports by each source, and an accuracy of prior reports from the source.

43. The method of claim 42, further comprising resolving inconsistencies in the received information based on the predicted reliability of the sources.

44. The method of claim 33, wherein the site fingerprint comprises the physical attributes of the site.

45. The method of claim 44, further comprising predicting a movement of the hazard based on the site fingerprint, and automatically adjusting the geo-fence to account for the physical attributes of the site.

46. The method of claim 33, wherein the overlay comprises a location of other users near the hazard.

47. The method of claim 33, further comprising assigning a checkpoint to the user based on a rule-based radius guide to determine an existence of the hazard.

48. The method of claim 33, further comprising assigning a checkpoint to the user based on a rule-based radius guide to determine a location, and surrounding circumstances, of the hazard.

49. (canceled)

50. The method of claim 33, wherein the updated information comprises a rate of motion of the hazard.

51. The method of claim 33, further comprising generating zones of danger associated with a hazard by applying a predefined trajectory algorithm to calculate a rate of motion of the hazard using a processor and based on the site fingerprint information including obstructions and terrain type affecting the rate of motion and direction of hazard.

52. The method of claim 51, further comprising presenting the zones of danger to the user via the interface.

53. The method of claim 49, further comprising requesting information about the hazard from the user via the interface at predefined intervals.

54-69. (canceled)
